(19) United States
(12) Patent Application Publication
(10) Pub. No.: US 2014/0067523 A1
(43) Pub. Date: Mar. 6, 2014

(54) SYSTEM AND METHOD FOR ONLINE SUBMISSION, COLLECTION, AND DISTRIBUTION OF PRODUCT AND SHOPPING RELATED INFORMATION

(71) Applicants: Kenneth A. Barnett, Bloomfield Hills, MI (US); John Andrews, Fayetteville, AR (US); Jay Thornton, Rogers, AR (US)

(72) Inventors: Kenneth A. Barnett, Bloomfield Hills, MI (US); John Andrews, Fayetteville, AR (US); Jay Thornton, Rogers, AR (US)

(73) Assignee: Collective Bias, LLC, Bentonville, AR (US)

(21) Appl. No.: 13/603,517

(22) Filed: Sep. 5, 2012

(51) Int. Cl. G06Q 30/02

(52) U.S. Cl. 705/14.45; 705/14.72

(57) ABSTRACT

A method includes receiving and storing, at a server, a project listing associated with a project that includes at least one shopping-related activity and providing access to the project listing to users. The method also includes receiving, at the server, a request for participation in the project from a user and receiving, at the server, approval for an approved user to participate in the project, based on the request. The method also includes receiving, at the server, a link to content generated by the approved user, the content being associated with the approved user's performance of the at least one shopping-related activity and the content including at least one of text content, image content, and video content. The method also includes providing, at the server, access to the link to the users.

### FIELD

The present disclosure relates to systems and methods for online submission, collection, and distribution of product and shopping related information and, in particular, to submission, collection, and distribution of user-generated content documenting user experiences related to products and shopping.

### BACKGROUND

This section provides background information related to the present disclosure which is not necessarily prior art.

Companies that are in the business of selling products to consumers, such as goods and services, generally need to communicate and advertise information about their products to consumers. For example, companies can generate advertising and marketing information that can be communicated and distributed to consumers in the form of television commercials, radio commercials, printed advertisements in magazines and newspapers, text and graphic advertisements on web pages, etc. These traditional forms of advertising and marketing, however, can sometimes fail to make a personal or emotional connection with the consumer.

On the other hand, a personal story from a fellow consumer with respect to the purchase and use of a particular product may impact the consumer on a personal and emotional level. In this way, personal stories and product recommendations from fellow consumers may be a more effective path for companies to communicate product information. Companies that are in the business of selling goods and services, however, are generally not able to access, guide, direct, or control these real-life stories about their products.

### SUMMARY

This section provides a general summary of the disclosure, and is not a comprehensive disclosure of its full scope or all of its features.

In various embodiments of the present disclosure, a method is disclosed that includes receiving and storing, at a server, a project listing associated with a project that includes at least one shopping-related activity. The method also includes providing, at the server, access to the project listing to a plurality of users. The method also includes receiving, at the server, at least one request for participation in the project from at least one user from the plurality of users. The method also includes receiving, at the server, approval for at least one approved user from the plurality of users to participate in the project, based on the at least one request for participation in the project. The method also includes receiving, at the server, a link to content generated by the at least one approved user, the content being associated with the at least one approved user's performance of the at least one shopping-related activity and the content including at least one of text content, image content, and video content. The method also includes providing, at the server, access to the link to the plurality of users.

In various embodiments of the present disclosure, a server is disclosed. The server includes a computer readable storage medium storing instructions executable by a processor for: receiving and storing a project listing associated with a project that includes at least one shopping-related activity; providing access to the project listing to a plurality of users; receiving at least one request for participation in the project from at least one user from the plurality of users; receiving approval for at least one approved user from the plurality of users to participate in the project, based on the at least one request for participation in the project; receiving a link to content generated by the at least one approved user, the content being associated with the at least one approved user's performance of the at least one shopping-related activity and the content including at least one of text content, image content, and video content; and providing access to the link to the plurality of users.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example system for online submission, collection, and distribution of product and shopping related information according to some embodiments of the present disclosure.

FIG. 2 is a flow chart illustrating a technique of the present disclosure.

FIG. 3 is a flow chart illustrating another technique of the present disclosure.

FIG. 4 is a flow chart illustrating another technique of the present disclosure.

FIG. 5 is an example screen shot of generated content in accordance with the present disclosure.

FIG. 6 is another example screen shot of generated content in accordance with the present disclosure.

FIG. 7 illustrates another example system for online submission, collection, and distribution of product and shopping related information according to some embodiments of the present disclosure.

FIG. 8 illustrates another example system for online submission, collection, and distribution of product and shopping related information according to some embodiments of the present disclosure.

FIG. 9 is a flow chart illustrating another technique of the present disclosure.

FIG. 10 illustrates another example system for online submission, collection, and distribution of product and shopping related information according to some embodiments of the present disclosure.

FIG. 11 is a flow chart illustrating another technique of the present disclosure.

FIG. 12 illustrates another example system for online submission, collection, and distribution of product and shopping related information according to some embodiments of the present disclosure.

Corresponding reference numerals indicate corresponding parts throughout the several views of the drawings.

### DETAILED DESCRIPTION

Example embodiments will now be described more fully with reference to the accompanying drawings.

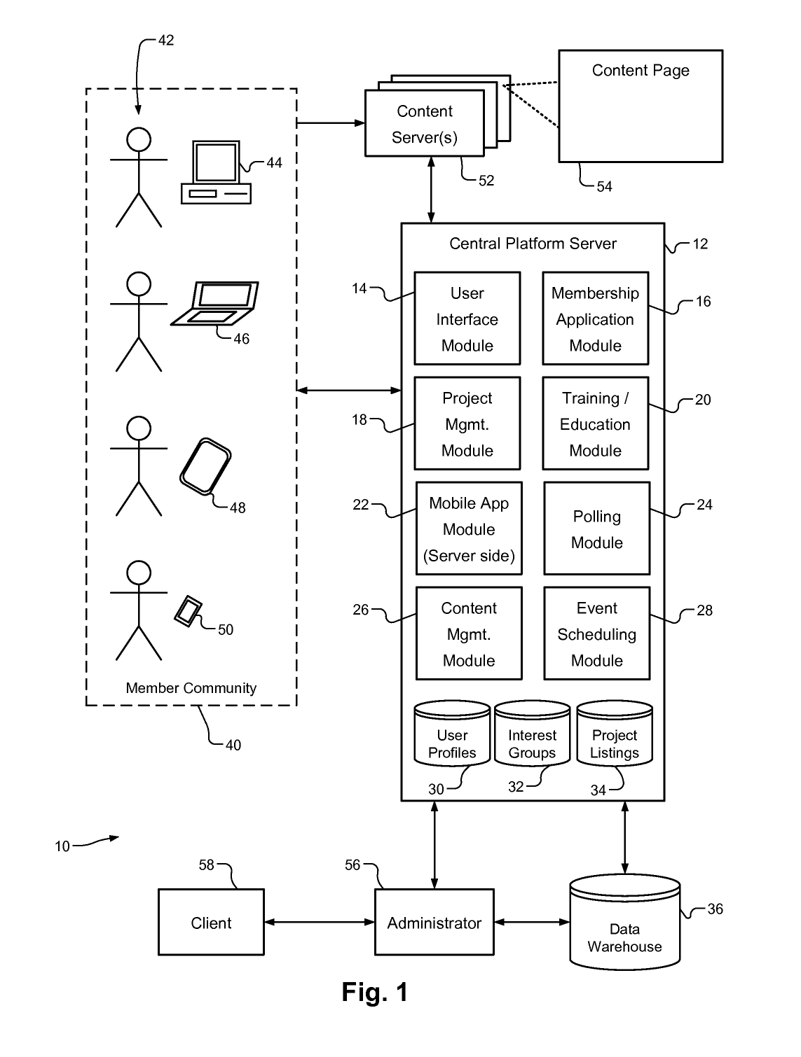

With reference to FIG. 1, a system 10 for online submission, collection, and distribution of product and shopping related information is shown and includes, for example, a central platform server 12 in communication with a group of users in a member community 40 that includes individual users or members 42. As described in further detail below, the member community 40 can be a closed or private group of members such that membership to the community is controlled via an application process whereby new member applications are reviewed, screened, and either accepted or rejected by an administrator 56 of the system.

The central platform server 12 may be a web server with a user interface module 14 that allows for members 42 to interact with the central server 12. For example, the central server 12 may be accessed via a web browser interface, wherein the user interface module 14 may generate hyper-text markup language (html) code with suitable input and output frames to receive input from users and to display output to users. As an example, the central platform server 12 may be built on a WordPress platform utilizing a BuddyPress plugin for social interaction, discussion groups, and forums and/or additional plugins to accomplish the functionality described herein.

The central platform server 12 may include a membership application module 16, a project management module 18, a training/education module 20, a mobile application module (server side) 22, a polling module 24, a content management module 26, and an event scheduling module 28. Further, the central platform server may also include one or more databases, such as a user profile database 30, an interest group database 32, and a project listings database 34. The various databases at the central platform server may be separate databases or incorporated and combined into a single database.

The central platform server 12 may be in communication with a data warehouse 36, which can be a high-speed database that contains a copy of the data stored at the central platform server 12 for easy access by other applications and modules outside of the central platform server 12.

The members 42 may include micro-publishers or bloggers that generate content that is stored on and accessible via one or more content servers 52. For example, the generated content may include a content page 54 such as a web page stored on a content server 52 and accessible over a network such as the internet. The members 42 may generate content using any number of devices, including, for example, a desktop computer 44, a laptop computer 46, a tablet device 48, a mobile device 50, such as a smartphone, or any other suitable computing device. Content generated by the member community 40 may be communicated to and stored and displayed at the content servers 52. For example, a community member 42 may operate a blog website with blog content viewable at a content page 54 that is stored and accessible over the internet through a content server 52.

Prior to being members of the member community 40, a user or prospective member may submit an application to become a member of the member community 40 via the membership application module 16 of the central platform server 12. For example, a membership application for an individual blogger or micro-publisher may be reviewed by an administrator 56 who may decide, based on the particular blogger's or micro-publisher's credentials, whether to include the particular member 42 in the member community 40. Alternatively, the member community 40 may be open to any blogger or micro-publisher that registers or requests membership into the member community 40.

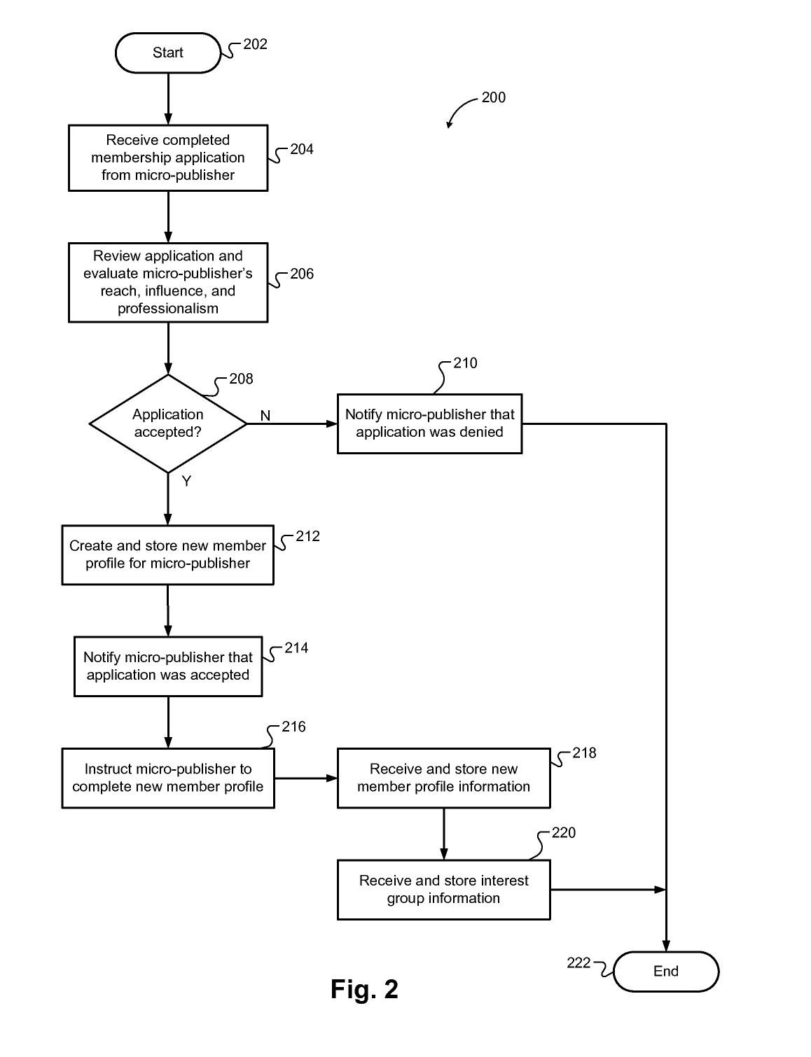

With reference to FIG. 2, a technique 200 for receiving and assessing new membership applications is shown. The technique starts at 202. At 204, the membership application module 16 of the central platform server 12 receives a completed membership application from a micro-publisher. The membership application module 16, for example, may provide an online form through the user interface module 14 that a prospective member may complete and submit. Data from the completed online form may then be communicated by the central platform server 12 to an administrator 56. At 206, an administrator 56 may review the completed application and evaluate the micro-publisher's credentials, including the micro-publisher's reach, influence, and professionalism. For example, the review may include a review of the micro-publisher's blog and content pages 54. The review may also use web and blogger analytics to determine the number of total and unique hits for the micro-publisher's blog and content pages 54 over a specified period of time. Further, the review may evaluate the micro-publisher's influence and reputation in the particular blogger community by reviewing any comments submitted with respect to the micro-publisher's content pages 54 and the content pages 54 and associated comments for other micro-publisher's content pages in the same or related fields. In this way, an evaluation may be made of the particular micro-publisher's reputation, standing, influence, and professionalism in the particular micro-publisher's field.

At 208, based on the review of the micro-publisher's application and the above described investigation, the application is either accepted or rejected. At 210, when the application is rejected, the micro-publisher is notified that the application was denied and the technique ends at 222.

At 212, when the application is accepted, a new member profile for the micro-publisher is created and stored in the user profile database 30 on the central platform server 12. At 214, the micro-publisher is notified by an administrator 56 that the application was accepted. At 216, the micro-publisher is instructed by an administrator 56 to complete the remaining fields of the new member profile. For example, the new micro-publisher may submit a picture for the user profile, personal information for the user profile including the micro-publisher's location and background, links to the micro-publishers blog and content pages 54, links to associated social media content, information with respect to the micro-publisher's blogging interests and specialties, etc. At 218, the new member profile information is received and stored.

The new micro-publisher may review the various interest groups stored in the interest group database 32 of the central platform server 12 and may select particular interest groups from the interest group database 32 that the micro-publisher has interest in. As discussed in further detail below, when new project listings are submitted, the micro-publisher's selected interest groups may help identify the micro-publisher as a possible candidate for a particular project. At 220, the interest group information is received and stored in the micro-publisher's user profile in the user profile database 30. At 222, the technique ends.

Alternatively, a particular micro-publisher may be invited to participate in the member community 40 by an administrator 56 without the micro-publisher first submitting an application. For example, if a particular micro-publisher has established a reputation in a particular field, an administrator 56 may ask the micro-publisher to participate in the member community 40.

After admission to the member community 40, an administrator may also provide a virtual tour of the central platform server 12 for the new micro-publisher as part of an orientation process. The new member may also be given an initial shopping task to perform. The new member may then generate content related to the new member's experience in performing the initial shopping task. The generated content can then be reviewed and critiqued by an administrator 56 as part of the orientation process for the new member.

Once a member community 40 is established, new projects may be submitted to the central platform server 12, through the project management module 18, for inclusion in the project listings database 34. Community members may then request to participate in a project from the project listings and may then generate content on their blogs and content pages 54 documenting their experience associated with their participation in the particular project.

A client 58, such as a company that sells products, including goods and services, may contact an administrator 56 and request initiation of a particular project centered around one or more of the company's goods or services. The administrator 56 may then create a custom project, including activities and tasks centered around and customized for the company's particular good or service, and submit it to the central platform server 12 for inclusion in the project listings database 34.

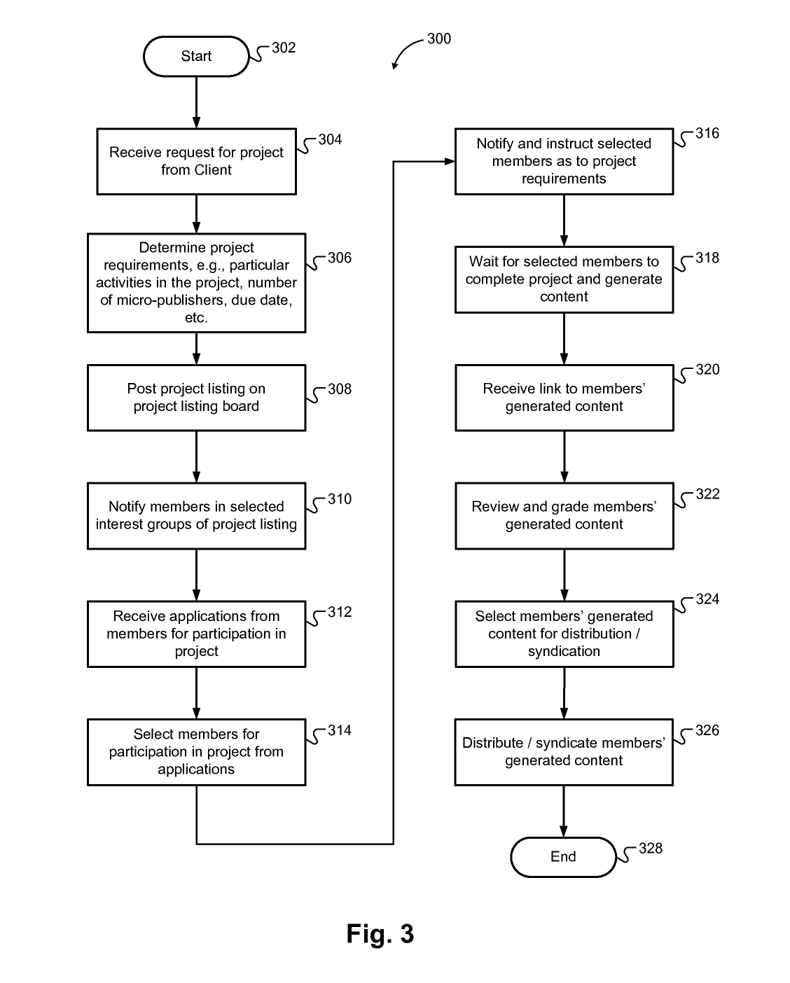

With reference to FIG. 3, a technique 300 for receiving, initiating, and participating in a particular project is shown. The steps of the technique 300 may generally be performed by the central platform server, in conjunction with an administrator 56, for example. The technique starts at 302.

At 304, a request is received by an administrator 56 from a client 58 for initiation of a particular project. For example, the client 58 may sell a particular food product, such as soup, and may request an administrator 56 to develop a customized project that centers around and features the client's particular brand of soup or a particular type of the client's brand of soup.

At 306, an administrator 56 may create a customized project for the client 58 based on the client's request. Specifically, the administrator 56 may determine particular activities related to the client's product to be included in the project. The administrator 56 may also determine the number of micro-publishers from the member community 40 to be included in the project. The administrator 56 may also determine the due date for completion of the project by the micropublishers. Any other customized requirements or features of the particular project may be included at 306. For example, the form or format of content generated by the micro-publishers as a result of the project may be specified.

The particular activities and tasks for the project related to the client product may include: a shopping trip to a particular store or type of store; generating content related to the user's experience in purchasing the product at the store; using the product in a certain way or with certain other types of products; generating content related to the user's experience in using the product. For example, if the product is a food item, the project could include using the food item as an ingredient in a recipe or preparing the food item for a particular type of meal or event, such as a family gathering or a party.

At 308, once the specification for the project is complete, a project listing is created and posted on the project listing board or project listing database 34 of the central platform server. At 310, particular interest groups are selected from the interest group database 32 of the central platform server and members of those particular interest groups are notified of the project and the project listing in the project listing database 34. For example, if the project involves a soup product, members of any food related interest groups may be notified.

At 312, after receiving notification of the project, micro-publishers from the member community 40 may submit applications to an administrator 56 to participate in the particular project. Applications for the particular project may be submitted through the user interface module 14 and project management module 18 of the central platform server 12 to an administrator 56.

At 314, after receiving applications for the project, an administrator 56 may select particular members or micro-publishers for participation in the project. Selection from the received applications may be based on the project requirements, the number of applications received, the types of micro-publishers the client would like to have involved, etc. For example, an administrator 56 may select micro-publishers for participation such that a broad cross-section of micro-publisher types is represented. Further, the selection may be based on individual and total micro-publisher reach and influence data. An administrator 56 may provide the identities of the approved members to the central platform server 12 through the user interface module 14 and project management module 18. The central platform server 12 may update the user profiles for the approved members in the user profile database 30 to indicate in each approved member's profile that the member is participating in the particular project. Additionally, an administrator 56 may select a particular approved member to serve as the leader of the approved members for the particular project. The leader may then assist other approved members, answer questions, and serve as a representative of the approved members for communications with an administrator 56.

At 316, the approved micro-publishers are notified of their acceptance into the project and provided instructions for their participation in the project. Specifically, the approved micro-publishers may be notified by the central platform server 12 via the project management module 18 and user interface module 14, or the approved micro-publishers may be notified directly by an administrator via email or other communication means, for example.

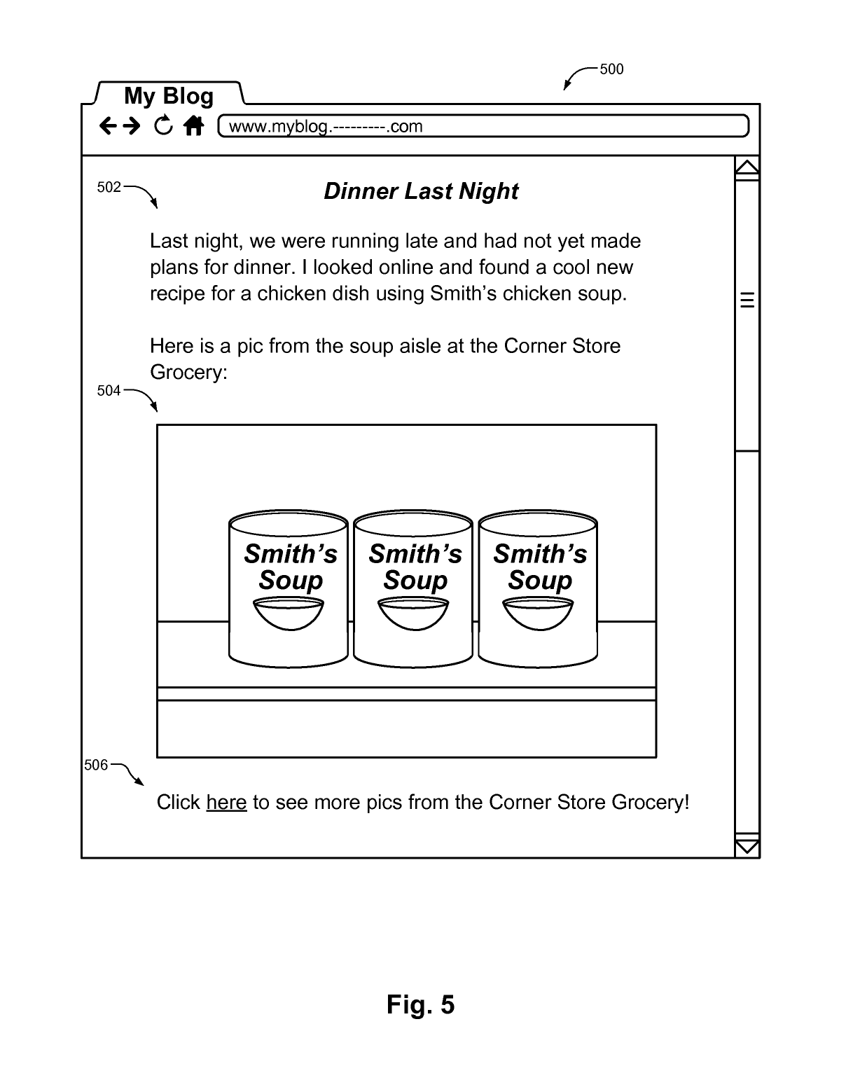

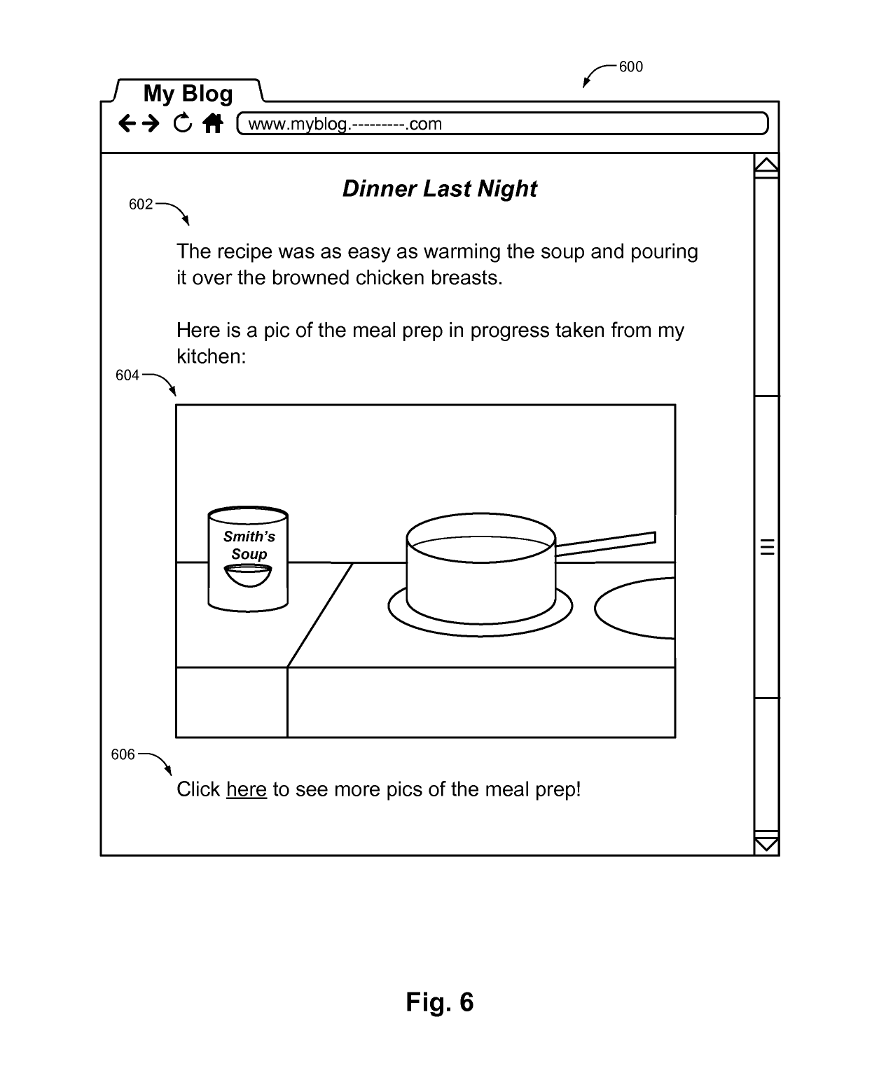

At 318, after notifying the approved members of their selection for the project, the administrator, and the central platform server may then wait for the approved members to complete the particular project and to generate any resulting content. At 320, once the each approved member completes the project, the approved member generates the corresponding content and submits a link to the generated content. For example, the micro-publisher may create a blog posting on a blog or content page 54, which may include text content, image content, and video content, for example, and may submit a link to that blog or content page 54. As discussed in further detail below, example content associated with a project involving “Smith's Soup” is shown in FIGS. 5 and 6.

The approved member may, for example, submit the link to the central platform server 12 via the user interface module 14 and the project management module 18. The central platform server 12 may update the user profile for the approved member in the user profile database 30 and may submit the link to an administrator 56. Alternatively, the approved member may submit the link to the generated content directly to an administrator 56.

At 322, an administrator 56 may review and grade the submitted content. Further, based on the review and grade, an administrator 56 may select some or all of the approved members that complete the project to be compensated for their participation in the project. An administrator 56 may submit a grade for the reviewed content to the central platform server 12 via the user interface module 14 and project management module 18. The central platform server 12 may store the grade for the reviewed content in the associated user profile for the approved member in the user profile database 30 for future reference. For example, the grade for the reviewed content may be considered in the member selection phase of a future project.

At 324, an administrator 56 may select some or all of the content generated by the approved members for further distribution or syndication. At 326, the selected members' generated content may be syndicated, as appropriate. For example, an administrator 56 may use the content management module 26 to post the link and/or the generated content on a content page, such as a blog associated with the central platform server and/or a blog associated with a corresponding interest group related to the particular project. Further, the link and/or generated content may be syndicated to social media outlets such as Facebook, Twitter, and the like. Specifically, the link and/or generated content may be syndicated and distributed to a social media channel that is specific to the particular approved member that generated the content, to a social media channel that is specific to an interest area related to the content, or to a social media channel associated with the central platform server or an administrator, for example.

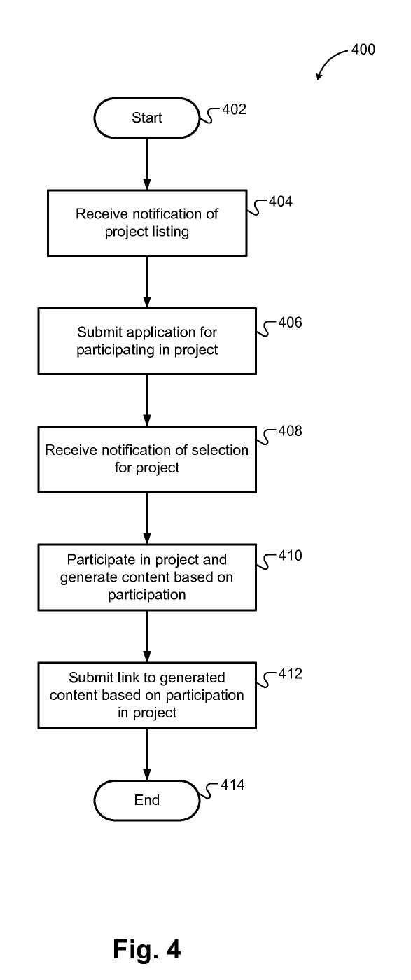

With reference to FIG. 4, a technique 400 for a micro-publisher participating in a project is shown. The steps of the technique 400 may generally be performed by one or more micro-publishers of the member community 40. The technique starts at 402.

At 404, the micro-publisher may receive a notification of the project listing. The micro-publisher may then interact with the central platform server via the user interface module 14 and project management module 18 to get details of the project listing from the project listing database 34.

At 406, the micro-publisher may submit an application for participation in the project. At 408, the micro-publisher may receive a notification from an administrator 56, either directly or via the central platform server, that the micro-publisher has been selected and approved for participation in the project.

At 410, the micro-publisher may participate in the project and generate content based on the participation. For example, the micro-publisher may document each step of the project and generate content, including text content, image content, and/or video content, showing each step of the project, including the associated product, for example.

At 412, after generating the content based on the participation, and posting the generated content at the micro-publisher's associated content page 54, for example, the micro-publisher may submit a link to the generated content. For example, the micro-publisher may submit a link to an administrator 56 through the user interface module 14 and project management module 18 of the central platform server 12. At 414, the technique ends.

With reference to FIGS. 5 and 6, examples of generated content for a project are shown. The example project relates to a “Smith's Soup” product. The project includes steps of: purchasing the Smith's Soup product at a store; generating content related to the purchase at the store; using the Smith's Soup product in a recipe; and generating content related to preparation of the recipe. As shown in FIG. 5, the generated content 500 includes text content 502 related to the purchase of the product. Further, the generated content 500 also includes image content 504 showing the product in the store on a shelf at the store. The generated content 500 also includes a link 506 to additional image content showing the product at the store.

As shown in FIG. 6, the generated content 600 also includes text content 602 related to the use of the product in a recipe. Further, the generated content 600 includes image content 604 showing the meal preparation using the product. The generated content 600 also includes a link 606 to additional image content showing the meal preparation using the product.

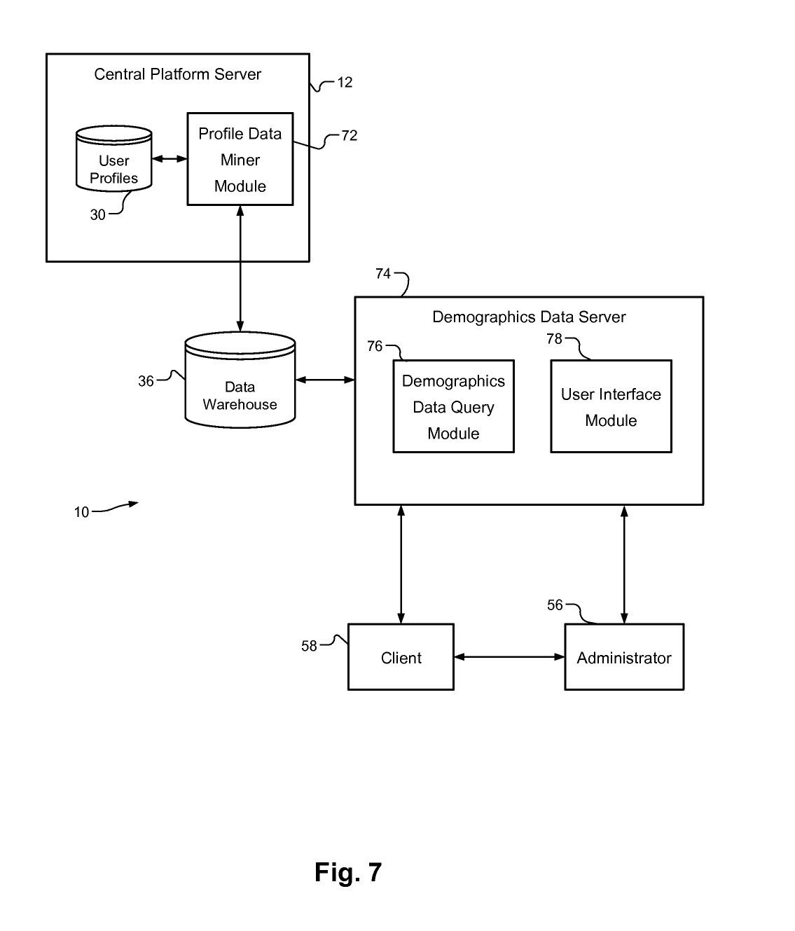

With reference to FIG. 7, the system 10 may include additional modules and components for providing anonymized demographic data based on the user profile data from members 42 of the member community stored in the user profile database 30 of the central platform server 12. Specifically, the central platform server 12 may include a profile data miner module 72 that mines and anonymizes the user profile data stored in the user profile database 30. The profile data miner module 72 stores the anonymized user profile data in the data warehouse 36.

As shown in FIG. 7, a demographics data server 74 may include a demographics data query module 76 and a user interface module 78 for interacting with a client 58 and/or an administrator 56. The demographics data query module 76 of the demographics data server 74 may receive a demographics query from a client 58 or administrator 56 and may provide anonymized user profile data in response to the query.

In this way, the entire member community 40 can be segmented into highly targeted smaller groups. As an example, a query may be submitted for all micro-publishers located in the states of Arkansas, Michigan, and Texas that are parents of two to three children, with associated blogs related to arts and crafts, and that are dog owners and prefer to shop at a particular store. In response to the query, the demographics data query module 76, based on the anonymized data stored in the data warehouse 36, may respond that there are a total of, for example, twenty micro-publishers in the member community 40 that satisfy the criteria of the query and that those 20 micro-publishers have a combined direct reach of 214,140 total unique users/readers.

By utilizing the demographics data server 74 and demographics data query module 76, a prospective client 58 and/or an administrator 56 that is considering initiation of a new project may be able to determine the number of micro-publishers that are well suited for participation in a particular project before initiating the project or submitting a project listing. Additionally, based on the demographics data, particular projects can be customized based on the likely group of project participants. For example, specific project requirements may be modified to suit a larger or narrower group of micro-publishers, based on the results of the demographic data and demographic data queries using the demographics data server 74 and demographics data query module 76.

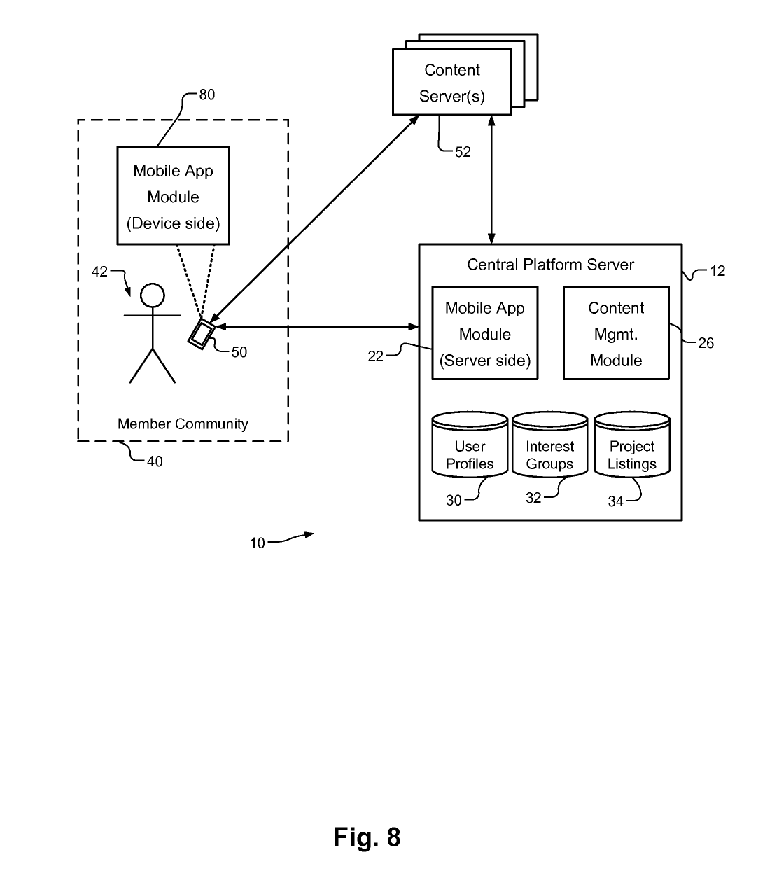

With reference to FIG. 8, a micro-publisher member 42 may utilize a mobile application module 80 executing on a mobile device 50, such as a smart phone, to generate content and interact with the content server(s) 52 and central platform server 12. Specifically, while a mobile application module 80 (device side) may be executing on the micro-publisher's mobile device, a mobile application module 22 (server side) may be executing on the central platform server 12.

The micro-publisher member 42 may use the mobile device 50 to take photos and images on-the-fly while participating in the project, and may generate and post content in real-time. Content generated with the mobile application module 80 (device side) of the mobile device 50 may be posted and submitted to the content servers 52 and to the central platform server 12. Alternatively, content generated with the mobile application module 80 (device side) of the mobile device 50 may be first posted and submitted to the mobile application module 22 (server side) and then posted and submitted from the central platform server 12 to the content server 52.

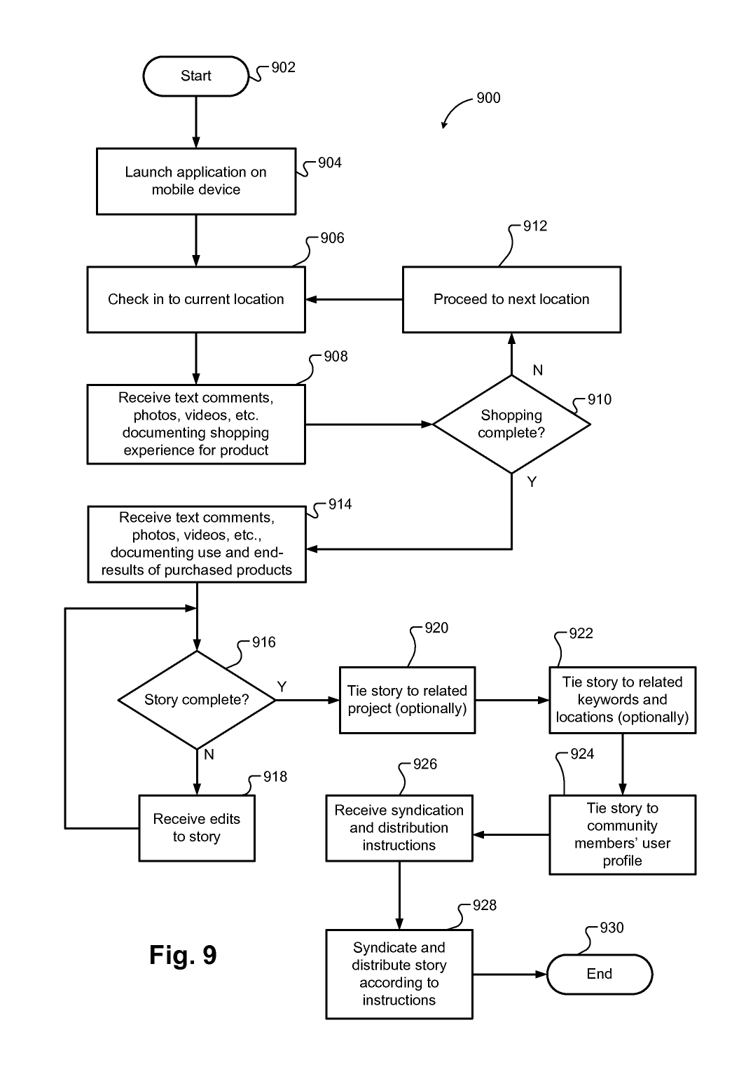

With reference to FIG. 9, a technique 900 for generating and submitting content with the mobile application module 80 (device side) is shown. The steps of the technique 900 may generally be performed by the mobile application module 80 (device side) operating on a mobile device 50, by a micro-publisher, and by the central platform server 12. The technique starts at 902.

At 904, the mobile application module 80 is launched on the mobile device 50. For example, if the project includes shopping for a product at a store, the mobile application module 80 may be initiated once the micro-publisher arrives at the store. At 906, the mobile application module 80 uses a GPS service on the mobile device 50 to check in to the current location. The check-in process may include using the GPS service to determine the current GPS location and to determine the specific store location of the micro-publisher/member 42 and mobile device 50. In this way, any content generated at this location may be tied to that specific store and location.

At 908, the mobile application module 80 may receive content in the form of text comments, picture images, video, etc. documenting the micro-publishers experience while participating in the project. Specifically, the text comments, picture images, video, etc. may document the micro-publisher's experience while shopping for the particular product involved in the project. For example, the content shown in FIG. 5 could be generated by a mobile application module 80 executing at 908.

When content generation is completed at the current location, the technique proceeds to 910. At 910, when shopping is not complete, the technique proceeds to 912 and the micro-publisher/member 42 and mobile device 50 proceed to the next location and then loop back to 906 to check in to the second location, and so on.

At 910, when the shopping portion of the project is complete, the technique proceeds to 914. At 914, the mobile application module 80 may receive content in the form of text comments, picture images, video, etc. documenting the use of the product while participating in the project. Specifically, the text comments, picture images, video, etc. may document the micro-publisher's experience while using the purchased products from the shopping trip. For example, the content shown in FIG. 6 could be generated by a mobile application module 80 executing at 914.

When content generation is completed at 914, the technique proceeds to 916. At 916, a determination is made as to whether the current story corresponding to the generated content is complete. At 918, when the story and content are not complete, edits to the story and content are received at 918 and the technique loops back to 916. Once the story and content are complete, the technique proceeds to 920.

At 920, the story and content can be tied to one or more specific related projects. Alternatively, the story and content could be generated by the micro-publisher without being tied to a specific project. At 922, the story and content can be tied to related keywords and locations. Specifically, the micro-publisher/member 42 can enter various keywords related to the story and content and indicate related locations associated with the story and content. At 924, the story and content can be tied to the micro-publisher's user profile stored in the user profile database 30 of the central platform server 12.

At 926, the mobile application module 80 may receive syndication and distribution instructions for the completed story and content. For example, the micro-publisher may specify and instruct that the completed story and content be submitted and published to the micro-publisher's blog and content page 54, to a blog and content page of the central platform server, to various social media outlets, etc. At 928, the mobile application module 80 (device side) and/or the mobile application module 22 (server side) may syndicate and distribute the story and content according to the micro-publisher's instructions. At 930, the technique ends.

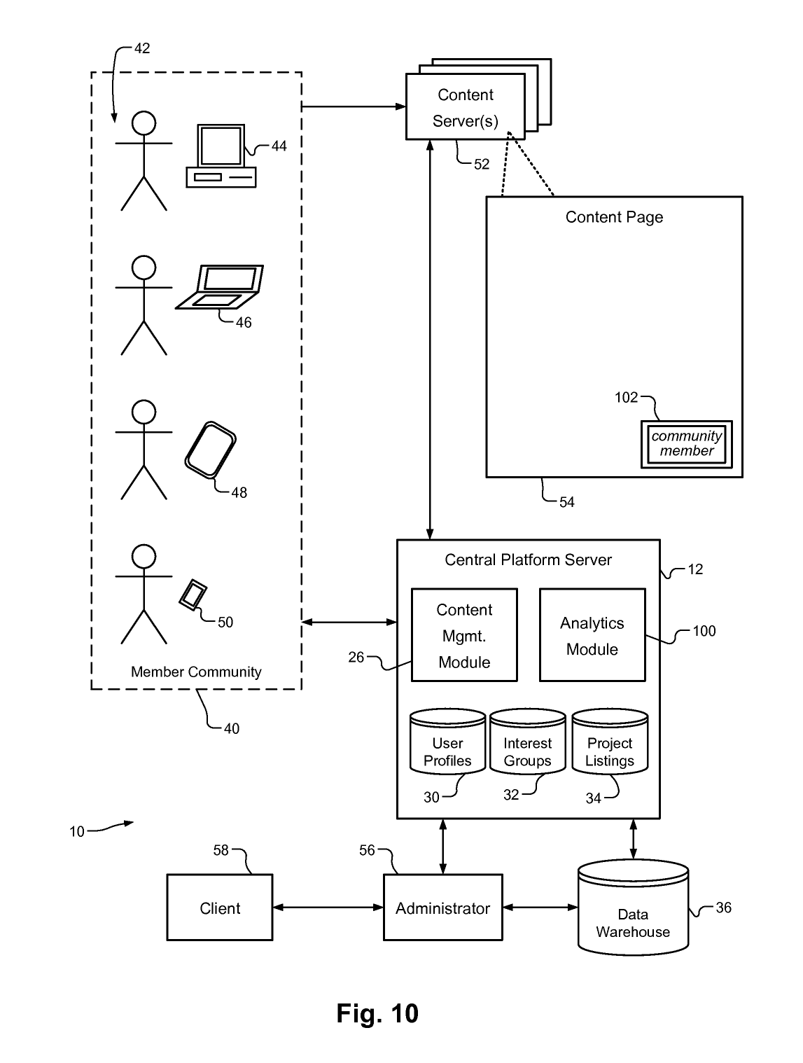

With reference to FIG. 10, the system 10 may allow micro-publisher members 42 to insert a badge 102 on their corresponding blog or content page 54 to indicate that the micro-publisher is a member of the member community 40. The badge 102 may include a unique code that is specific to that micro-publisher. The central platform server 12 may include an analytics module 100 that can track data related to view of the particular content page 54 displaying the micro-publisher's badge 102. For example, the unique code embedded with the badge 102 may contain unique identifiers that facilitate tracking, by the analytics module 100, of all page view, referrer, and timestamp data. More specifically, the page view, referrer, and timestamp data tracked through the unique code of the badge 102 can be tied to the particular user name or user identification number associate with that particular micro-publisher. The page view, referrer, and timestamp data can be automatically fed back to the central platform server 12 by the analytics module and stored in the micro-publisher's associated user profile in the user profile database and/or in the data warehouse 36.

The data collected by the analytics module 100 through the use of the badge 102 can then be used for future projects in determining that particular micro-publisher's reach and influence and to evaluate the total reach and influence of an interest group associated with the particular micro-publisher/member 42, or the member community 40 as a whole. Additionally, the tracking and analytics data collected by the analytics module can also be used in conjunction with the demographics data collected by the profile data miner module 72 and stored at the demographics data server 74, discussed above with respect to FIG. 7.

With reference again to FIG. 1, the central platform server 12 may include a training/education module 20 that may facilitate training and education of the members 42 of the member community 40 through online classes. For example, the training/education module 20 may provide a class listing board of available courses and associated date and time information when the online classes will be available. The courses can be live online classes, such that members 42 view and participate in the classes online in real time. Alternatively, the courses can be previously recorded and the members 42 can view the classes at a time of their choosing. The online classes may be taught by an administrator 56, for example, who may be an expert in a particular subject matter, process, or area of interest. Classes can also be sponsored by a particular company or client 58 and serve to educate members 42 with respect to a particular product, service, or brand. The classes can also relate to improving the members' skills with respect to generating content. For example, the classes can relate to writing skills, photography skills, videography skills, web design skills, etc.

Once a member 42 completes a class, the user may receive a certificate and the central platform server 12 may update the member's profile, stored in the user profile database 30, to indicate that the member 42 has completed the course. This information may be used in the future in selecting the particular member 42 for possible future projects.

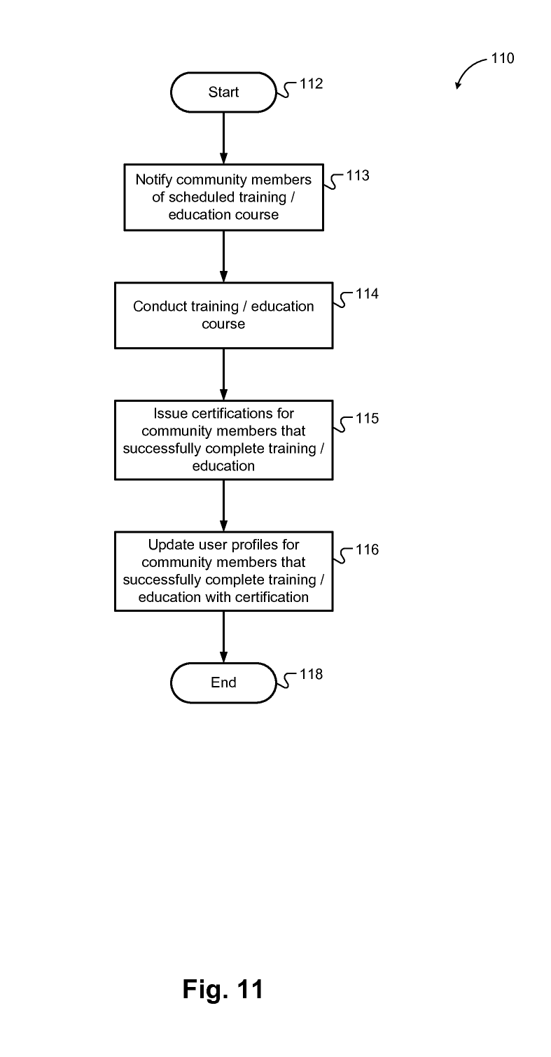

With reference to FIG. 11, a technique 110 for providing online training and education courses is shown. The steps of the technique 110 may generally be performed by the central platform server 12 and/or an administrator 56. The technique starts at 112.

At 113, community members 42 are notified of scheduled training/education courses that are available online. The notification may be sent to members 42 by an administrator 56 through the training/education module 20 or directly via email, text, or other communication means.

At 114, the online training/education course is conducted. As discussed above, the course may be a live class, whereby members 42 may watch a live real-time stream of the class, or the class may be recorded and viewed by members at any time.

At 115, certifications are issued by an administrator for community members 42 that successfully complete the training/education course. At 116, user profiles for community members that have successfully completed the training/education class may be updated to reflect the successful completion. The updated user profiles, for example, may be stored in the user profile database 30 of the central platform server 12. The technique ends at 118.

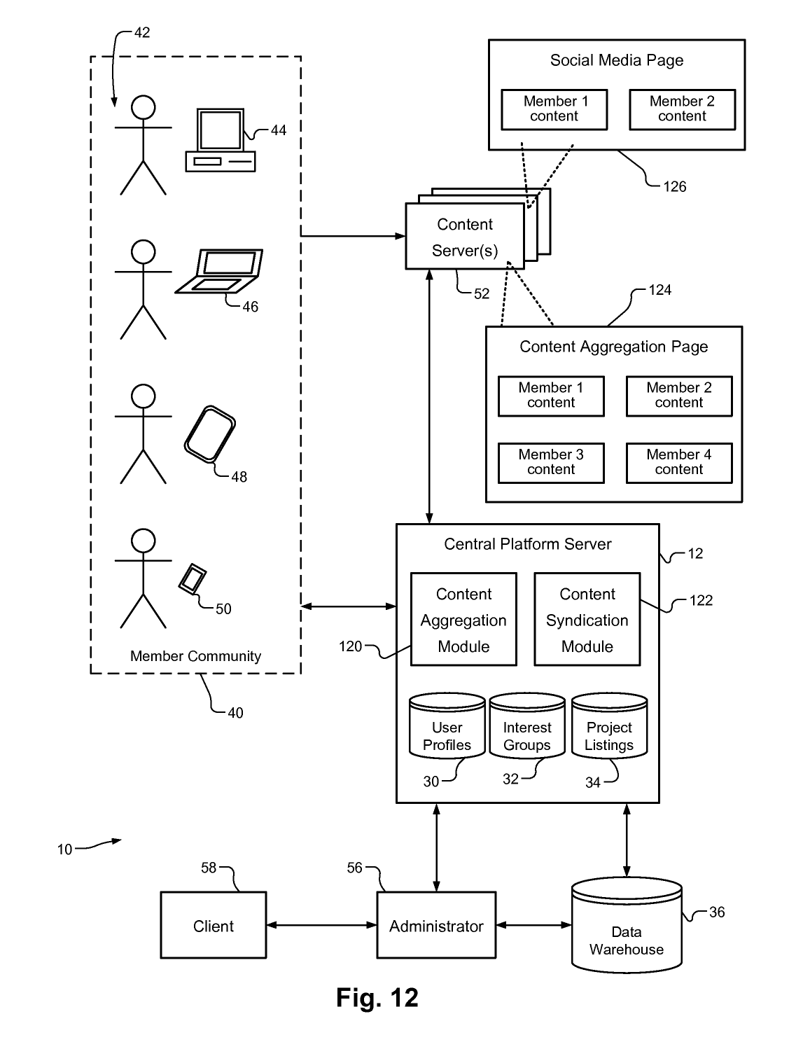

With reference to FIG. 12, the system may allow for member generated contented to be aggregated and syndicated to other content pages and social media outlets to increase viewing and distribution of the member generated content. For example, the central platform server 12 may include a content aggregation module 120 and a content syndication module 122.

The content aggregation module 120 may aggregate similar content on a content aggregation page 124. For example, the content aggregation module 120 may include all member generated content related to a particular project onto a single content aggregation page 124, which may include content from multiple different members 42. For example, in FIG. 12, the content aggregation page 124 include content from Member 1, content from Member 2, content from Member 3, and content from Member 4. The content shown on the content aggregation page may be a copy of the actual content or may be a link to the member's content on the member's blog or content page. Additionally, content from different members related to a particular interest group, or that is tagged with the same or similar keywords may be aggregated on a content aggregation page.

The content syndication module 122 may publish the member generated content at various other content outlets, such as other social media outlets. As shown in FIG. 12, a social media page 126 contains content from Member 1 and content from Member 2. Social media outlets may include, for example, Facebook and Twitter. The social media page 126 may be related to a particular project or a particular interest group. Additionally, the social media page 126 may include member content that is tagged with the same or similar keywords.

Additionally, the content aggregation module 120 and/or the content syndication module 122 may aggregate and/or syndicate member generated content from particular featured members. In this way the content provided on the content aggregation page 124 or the social media page 126 may be related to different projects, interest groups, or keywords, but may be from selected micro-publishers from the community of members.

With reference to FIG. 1, the central platform server 12 may include additional modules. For example, the central platform server 12 may include a polling module 24 that can be used by an administrator 56 to submit polls or queries to the community of members. The polls can be used to gauge the interest from the member community 40 in a particular project or subject area or to solicit input on a particular topic, for example a change to the functionality or format of the central platform server 12.

The central platform server 12 may also include an event scheduling module 28 that can coordinate events for particular members 42 or for the member community 40 as a whole. For example, the event scheduling module 28 can track project deadlines, classes, member birthdays, etc. Certain members or member groups can then be appropriately notified of upcoming scheduled events.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Further, example embodiments are provided so that this disclosure will be thorough, and will fully convey the scope to those who are skilled in the art. Numerous specific details are set forth such as examples of specific components, devices, techniques, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

As used herein, the term module may refer to, be part of, or include: an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses, techniques, and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

What is claimed is:

1. A method comprising:
receiving and storing, at a server, a project listing associated with a project that includes at least one shopping-related activity;
providing, at the server, access to the project listing to a plurality of users;
receiving, at the server, at least one request for participation in the project from at least one user from the plurality of users;
receiving, at the server, approval for at least one approved user from the plurality of users to participate in the project, based on the at least one request for participation in the project;
receiving, at the server, a link to content generated by the at least one approved user, the content being associated with the at least one approved user's performance of the at least one shopping-related activity and the content including at least one of text content, image content, and video content; and
providing, at the server, access to the link to the plurality of users.

2. The method of claim 1, wherein the plurality of users are members of a user group, the method further comprising:
receiving, at the server, a request from a new user for inclusion of the new user in the user group;
receiving, at the server, approval of the new user for inclusion in the user group; and
storing, at the server, a user-profile associated with the new user.

3. The method of claim 1, wherein the project is associated with a predetermined product and each shopping-related activity of the project is related to the predetermined product.

4. The method of claim 1, further comprising at least one of:
distributing the link to at least one social media outlet; and
submitting the link for inclusion on at least one content aggregation page.

5. The method of claim 1, further comprising:
receiving, at the server, user profile information associated with each user of the plurality of users;
storing the user profile information at a database connected to the server;
anonymizing the user profile information stored at the database;
receiving, at the database, a query for user profile information; and
providing anonymized user profile information from the database in response to the query.

6. The method of claim 1, further comprising:
receiving, at the server, traffic data for a web page associated with the link to the content generated by the at least one approved user; and
storing, at the server, the traffic data in a user profile associated with the at least one approved user.

7. The method of claim 1, further comprising:
providing, at the server, a listing of interest groups; and
storing, at the server, at least one interest group from the listing of interest groups in a user profile associate with each user from the plurality of users.

8. The method of claim 7, further comprising:
inviting at least one user from the plurality of users to participate in the project based on the at least one interest group stored in the user profile associated with the at least one user.

9. The method of claim 1, further comprising:
receiving, at the server, the link to the content generated by the at least one approved user from a mobile application of a mobile device utilized by the at least one approved user to generate the content.

10. The method of claim 1, further comprising:
providing, at the server, links to at least one training or education course;
receiving, at the server, data indicating that at least one user from the plurality of users has completed the at least one training or education course; and
storing, at the server, data indicating that the at least one user has completed the at least one training or education course in a user profile associated with the at least one user.

11. A server with a computer readable storage medium storing instructions executable by a processor for:
receiving and storing a project listing associated with a project that includes at least one shopping-related activity;
providing access to the project listing to a plurality of users;
receiving at least one request for participation in the project from at least one user from the plurality of users;
receiving approval for at least one approved user from the plurality of users to participate in the project, based on the at least one request for participation in the project;
receiving a link to content generated by the at least one approved user, the content being associated with the at least one approved user's performance of the at least one shopping-related activity and the content including at least one of text content, image content, and video content; and
providing access to the link to the plurality of users.

12. The server of claim 11, wherein the plurality of users are members of a user group, the computer readable storage medium storing further instructions executable by the processor for:
receiving a request from a new user for inclusion of the new user in the user group;
receiving approval of the new user for inclusion in the user group; and
storing a user-profile associated with the new user.

13. The server of claim 11, wherein the project is associated with a predetermined product and each shopping-related activity of the project is related to the predetermined product.

14. The server of claim 11, the computer readable storage medium storing further instructions executable by the processor for:
distributing the link to at least one social media outlet; and
submitting the link for inclusion on at least one content aggregation page.

15. The server of claim 11 the computer readable storage medium storing further instructions executable by the processor for:
receiving user profile information associated with each user of the plurality of users;
storing the user profile information at a database connected to the server;
anonymizing the user profile information stored at the database;
receiving a query for user profile information; and
providing anonymized user profile information from the database in response to the query.

16. The server of claim 11 the computer readable storage medium storing further instructions executable by the processor for:
receiving traffic data for a web page associated with the link to the content generated by the at least one approved user; and
storing the traffic data in a user profile associated with the at least one approved user.

17. The server of claim 11 the computer readable storage medium storing further instructions executable by the processor for:
providing a listing of interest groups; and
storing at least one interest group from the listing of interest groups in a user profile associate with each user from the plurality of users.

18. The server of claim 17 the computer readable storage medium storing further instructions executable by the processor for:
receiving an invitation for at least one user from the plurality of users to participate in the project based on the at least one interest group stored in the user profile associated with the at least one user; and
communicating the invitation to the at least one user from the plurality of users.

19. The server of claim 11 the computer readable storage medium storing further instructions executable by the processor for:
receiving the link to the content generated by the at least one approved user from a mobile application of a mobile device utilized by the at least one approved user to generate the content.

20. The server of claim 11 the computer readable storage medium storing further instructions executable by the processor for:
providing links to at least one training or education course;
receiving data indicating that at least one user from the plurality of users has completed the at least one training or education course; and
storing data indicating that the at least one user has completed the at least one training or education course in a user profile associated with the at least one user.
